(19) United States
(12) Patent Application Publication
(10) Pub. No.: US 2009/0292379 A1
(43) Pub. Date: Nov. 26, 2009

(54) Automated machining of dental block grafts and machining of biocompatible material for bone augmentation

(76) Inventor: Richard J. Pitz, New York, NY (US)

Correspondence Address: RICHARD J. PITZ, 400 E. 54th ST, New York, NY, 10022, US

(21) Appl. No.: 12/454,656

(22) Filed: May 21, 2009

Related U.S. Application Data
(60) Provisional application No. 61/128,744, filed on May 24, 2008.

(51) Int. Cl. G06F 17/50

(52) U.S. Cl. 700/98; 700/160

(57) ABSTRACT

A method of fabricating dental block grafts using automated cad/cam machining from digital models generated from CAT scans; where the scans are generated into virtual three dimensional models using computerized software; such models allow for a virtual restoration to be generated; production of the solid grafts are fabricated by the cad/cam machines using the algorithms generated by the software.

### BACKGROUND OF THE INVENTION

1) Field of the Invention

The present disclosure is directed to the use of cat scans and computer algorhythms to drive cad/cams machines to produce solid objects.

2) Description of Related Are

Bone grafting has been used in many forms in dentistry for many years. The grafting materials can be broken down into Autografts (from the patients own bone) Allografts (freeze dried cadaver bone and the like) and Xenografts (from other species or fabricated from materials that are biologically active in humans. Such as cow shin bone but not limited to that particular species). Each one has advantages and disadvantages.

Depending upon the type of defect, its location and the medical condition of the patient and the quality of the underlying bone, a certain amount of predictability can be assumed. Grafts from the patients own bone are usually used for small periodontally involved lesions. Large amounts of the patients bone cannot be harvested without the possibility of infection and certainly morbidity. These can be time consuming procedures.

They give the best result on average.

Allografts (freeze dried bone and the like) come in solid blocks and granules of all sizes. They are very predictable and since they do not require a surgery on the patient to harvest bone they are liked by the patient and the doctor. The granules require sequestration. Unless confined to an area they will migrate and there will be soft tissue migration into the graft making it useless. To mitigate such migration, barriers both resorbable and nonresorbable are used. Since allografts, must resorb and be replaced by natural bone, the time the graft is in place is imperative. Resorbable barriers may break down prior to new bone be laid down and as a result you may get no bone or you may get a small amount. In addition, the granules cannot be fixed in one spot. The overlying tissue is flexible and the barrier is not stiff and so the granules have a tendency to move. Thus the ideal placement for this material is class I lesions where the material is confined into a predictable area. Non resorbable membranes require a second surgery to be removed. This induces possible of infection, certainly morbidity. Reinforced nonresorbable barriers containing titanium metal that was bendable was introduced as a way to overcome the deficiencies of the soft barriers. They were very difficult to place and there are almost always incidents of the barriers coming through the overlying soft tissue. They were screwed to the underlying bone but there was no real intimate contact with the bone and as a consequence, they leaked the granules and soft tissue migrated along the margins. They required a second stage surgery with the morbidity and if implants were to be placed in these areas, it required a second surgery.

Solid block grafts using freeze dried human bone or freeze dried cow shin bone have been successful, however, their success if directly related to intimate contact with the underlying patient's bone. They must be screwed into place to prevent slipping; they must have a second surgery to remove the titanium screws that hold them in place and frequently additional bone augmentation material must be placed as the second stage where there was no intimate contact with the underlying human bone. Frequently the contour and amount of bone varies and bone recontouring must be done for adequate esthetics. Often the augmentation procedure is done in one stage and then the implants are done in the second stage. Again more cost, more morbidity, or chance of infection with this procedure.

Another major problem with the above grafting procedures is that while they may allow for thickness of bone on the labial or buccal side of the underlying natural bone, they do not allow for a predictable increase in the height of the bone. Mandibular block grafts are used in certain cases but have the shortcomings among which are 1) relatively poor contact with the underlying bone 2) mechanical adjustment to the bone to achieve the contact necessary 3) second stage to remove the titanium screws.

Placing these grafts as to type, size and procedure is done when the tissue is raised and the surgeon has the ability to see first hand the nature of the defect. This despite that in most cases a CAT scan is taken which allows for an evaluation of the defect.

Failure to provide adequate bone can cause implant failure, poor implant to crown ratio, poor esthetics and tissue problems such as, migration, no attached gingival at the implant/crown interface or chronic inflammation among others. Poor implant angulation where the implant fails to mimic the angulation of the adjacent teeth leads to additional expense with angulated tooth abutments which can add to additional stress placed upon the implant.

Maxillary bone augmentation in the posterior is complicated by the sinus. Thin walled sinus with inadequate bone height requires sinus membrane lifts with particulate bone grafting done through a window in the lateral wall of the sinus. This procedure is very technique sensitive and requires a long healing time and is fraught with post operative problems such as morbidity, infection and the inability to know if the graft has taken. The description and illustrations of the invention allows for the elimination of opening the sinus wall and inserting particulate matter and a membrane.

The prior art for bone augmentation in dentistry relies almost exclusively on patents on the chemistry, method of manufacture and efficacy of the individual products that comprise the state of the art in bone augmentation.

For example, once the methods of bone augmentation were described for the transfer of the patients own bone from productive sites to the deficient sits, it became incumbent on producing other materials that could make up for the deficient patient bone to biologically active substitutes. Patents for the production of freeze dried cadaver bone (allographs) were granted on the chemistry and fabrications of these substitutes, which includes block grafts as well as granular materials. The same can be said for xenografic materials and barrier membranes. These patents were granted when the need for them arose within the profession. Patents for the incorporating methods of measuring spaces using cat scans/cad/cam combinations in dentistry range from automated orthodontic wire bending to fabrication of synthetic bone augmentation using stereolithographic technology. Such patents have been issued to Ethicon and GeoDigm among others. These patents (Rudger; Rubbert U.S. Pat. No. 7,379,584) deal with the fabrication of appliances of all types that are to fixed to teeth or bone. They fabricate such appliances but do not address a method of fixing the appliances to other entities of the oral cavity, save the orthodontic modalities. The orthodontic patents uses other patented fixating devices such as brackets and springs to allow for the cad/cam fabricated wires to be fixed using dimensions from a scan. The Ethicon patent relies on the fabrication of a bone substitute by using a cat scan sent to a computer where the alogrhythms are sent to a stereolithography printer where a synthetic bone material with pore size that will allow for osteoconductive activity to take place. No mention is made for the need to stabilize such grafts or the method of placement.

Other prior art (Martinetti, Roberta et. al. #20080243458) rely on a cat scan to fabricate and intermediate model using stereolithography, forming a model to make a negative mold then producing a sintered semi ceramic product with controlled porosity.

Patents for various type screws to secure metal plates to bone and block grafts have been issued. Bioabsorbable screws for the fixation of bone fragments and grafts have been issued for example Linvatec and Acumed LLC Methods of combining individual patents products and devices to produce a unique method of fabrication, insertion and fixation of computer generated and fabricated block grafts has not been found.

### A BRIEF SUMMARY OF THE INVENTION

The present invention is directed toward a shaped structure fabricated out of allograft bone tissue that would restore defects in dental bone.

The preferred bone structure is comprised of an intimate mating surface at all points to the underlying defect whose surface has been measured by a 3d Volumetric Cat Scan. The scan is then converted into STL files where a computer converts such files into a virtual 3d model. The bony defect, once defined can be virtually restored by an acceptable computer program designed for such additions to any surface. The virtual bone restoration is converted into a solid model by allowing a cad/cam machine to fabricate the actual restoration using an algorithm that will drive such machine.

The exterior surface of the bone structure when implanted into the accepted site mimics the thickness and length of the bone to an acceptable shape such that it would allow for the preparation and placement of an implant(s).

At least one fastener threaded or interference fit can be placed through the bone structure into the underlying natural bone. The angle of such fastener is to be determined by the virtual model prior to fabrication. This angle of insertion is used primarily to avoid screws engaging the roots of adjacent teeth or anatomical landmarks such as sinus floors, arteries, nerves or veins.

It is an object of this invention that by using screws, pins and the like, fabricated from bioresorbable materials that a second stage surgery to recover any non resorbable fixation device will be avoided.

It is another object of this invention to fabricate the bone structure in such manner that the intimate mating surface is only on the periphery surround the bone object and the interior from the periphery is hollowed out to allow for other bone grafting materials such as granules of allografts or other bone inducing materials such as bone morphogenic proteins but not limited to such materials.

These and other advantages and novel features of the present invention will become apparent when considered with the teachings contained in the detailed disclosure along with the accompanying drawings.

### REFERENCES CITED

U.S. Patent Documents

| | | |
|---|---|---|
| 7,128,856 | October 2006 | Lin; Jiin-Huey Chern |
| 7,163,2007 | January 2007 | Knaack et al. |
| 7,179,299 | February 2007 | Edwards et al. |
| 7,235,079 | June 2007 | Jensen, David et al. |
| 7,383,163 | January 2008 | Holberg, Christoff |
| 7,323,193 | January 2009 | Morris et al. |
| 7,491,237 | February 2009 | Randall et al. |
| 20080243458 | October 2008 | Martinetti et al. |

### DESCRIPTION OF THE DRAWINGS

FIG. 1 Represents a lateral view of the bone graft (3) placed in intimate contact with the underlying bone (1). The figure also shows the insertion of the resorbable screw that would allow for the fixation of the graft (3) to the underlying bone (1). The figure also shows the length of the bone graft (3) and the intimate fit between the bone graft (3) and the underlying bone (1) as described in the patent.

FIG. 2 Represents a frontal view of the bone graft (4) whose margin can be shown in an intimate fit to the underlying bone (1). The figure also shows multiple screws (2) that may be used to secure the graft (4) to the underlying bone (1) The figure also shows the additional bone length (3) that may be gained by the claims of the present invention.

FIG. 3 Represents a frontal view of the sinus where an implant (3) secures bone graft (2) to the underlying maxillary sinus bone (1). The figure also shows sinus bone (4) pushed into the sinus by a trephination technique to allow for added bone height necessary for the implant to resist occlusal forces. The figure also shows the intimate contact that can be attained by the present invention at the interface of the bone implant (2) and the underlying sinus bone (1)

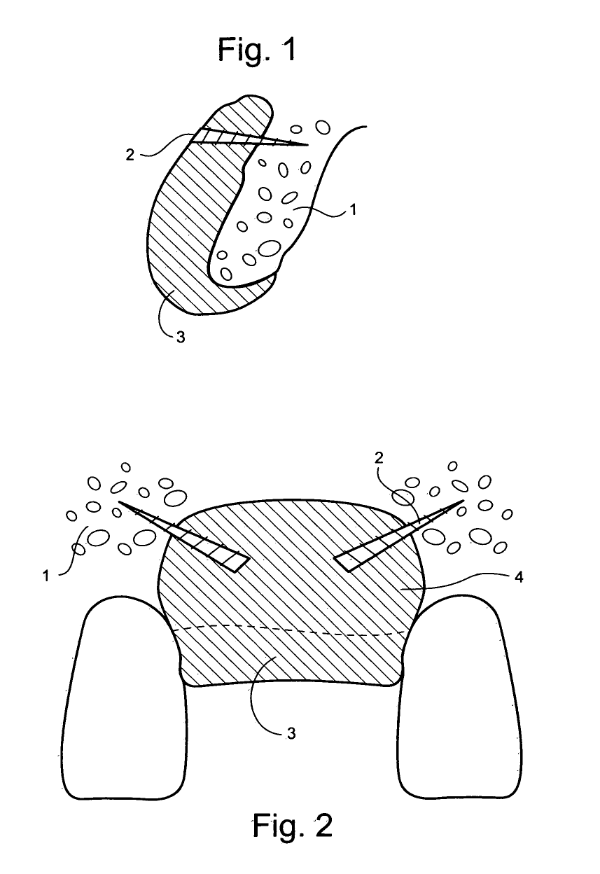

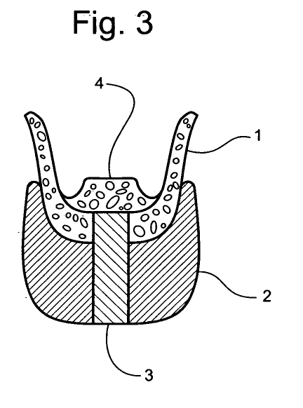

1. A method for the production of biologically active restorations for dental bone defects comprising a dental 3d volumetric CAT scan converted into a virtual three dimensional computerized model where a three dimensional restoration is produced over the defect; allowing a cad/cam milling machine to convert the appropriate generated algorhythms into the appropriate sized solid restoration.

2. A method for the production of biologically active restorations of claims where any allographic bone material, any xenografic material or any man made material suitable for the acceptance by the body for the induction of bone or the conduction of bone growth may be fabricated by the method described in claim 1

3. A method for the production of biologically active restorations where such restorations are immobilized to the underlying bone by fixation.

4. A method for the production of biologically active restorations as in claim 3 where such fixation could be any bone cement, biologically active materials such as bone morphogenic proteins but not limited to such proteins or materials, mechanical fixation, such as screws, tacks and the like but not limited to such materials.

5. A method for the production of biologically active restorations as in claim 4 where mechanical fixation methods such as screws but not limited to such devices are fabricated from resorbable material such as polylactic acid, potassium sulphate/polylactic acid combinations, bone or any suitable boiologically acceptable resorbable material.

6. A method for the production of biologically active restorations as in claim 1 where the intimate side of the reconstruction fits precisely to the underlying bone in all directions.

7. A method for the production of biologically active restorations as in claim 1 where a restoration is fabricated as a shell allowing for only the margins of the restoration to be in contact to the underlying bone to allow for fixation.

8. A method for the production of biologically active restorations as in claim 1 where a restoration may be attached to the underlying bone in the maxilla or mandible by using an implant to secure such a restoration.

9. A method for the production of biologically active restorations as in claim 1 where any shape appropriate to restoring of bony defects including width, length, or combinations of such but not limited to any configuration may be produced by the claimed method.

10. A method for the production of biologically active restorations as in claim 5 where the shape and number of resorbable devices is not limited.

11. A method for the production of biologically active restorations as in claim 7 where particulate matter of any type such as granules but not limited to such materials may be combined with the shape of the restoration as described in claim 7.

12. A method for the production of biologically active restorations as in claim 1 where the initial CAT scan is transmitted over the internet utilizing computer programs that allow for the resolution of any discrepancy between the prescribed model and the actual restoration.
